(19) United States
(12) Patent Application Publication
(10) Pub. No.: US 2015/0221959 A1
(43) Pub. Date: Aug. 6, 2015

(54) INTEGRATED COMPLEX ELECTRODE CELL HAVING INNER SEAL STRUCTURE AND REDOX FLOW CELL COMPRISING SAME

(71) Applicant: KOREA INSTITUTE OF ENERGY RESEARCH, Daejeon (KR)

(72) Inventors: Chang-Soo Jin, Daejeon (KR); Jae-Deok Jeon, Daejeon (KR); Bum-Suk Lee, Daejeon (KR); Joonmok Shim, Daejeon (KR); Kyoung-Hee Shin, Daejeon (KR); Sea-Couk Park, Daejeon (KR); Myung Seok Jeon, Daejeon (KR); Kyu-Nam Jung, Daejeon (KR); Sun-Hwa Yeon, Daejeon (KR); Sukeun Yoon, Daejeon (KR)

(21) Appl. No.: 14/426,511

(22) PCT Filed: Jan. 30, 2013
(86) PCT No.: PCT/KR2013/000765

§ 371 Date: Mar. 6, 2015

(30) Foreign Application Priority Data
Sep. 10, 2012 (KR) 10-2012-0099919
Sep. 11, 2012 (KR) 10-2012-0100257

(51) Int. Cl. H01M 8/02; H01M 8/20; H01M 8/18

(52) U.S. Cl. CPC H01M 8/0258; H01M 8/188; H01M 8/20

(57) ABSTRACT

A laminated structure of a redox flow cell, an integrated complex electrode cell, and a redox flow cell comprising same, wherein the integrated complex cell can reduce stack lamination process time and lamination cost and increase lamination efficiency by integrating a manifold and a bipolar plate in order to facilitate lamination. The integrated complex electrode cell having an inner seal structure, which inhibits the overflow of electrolytes, is characterized in that it inhibits the overflow of electrolytes of positive and negative poles by forming a structure in which an integrated part of the manifold and the bipolar plate can be sealed.

### TECHNICAL FIELD

The present invention relates to an integrated complex electrode cell capable of increasing the stacking efficiency, and a seal structure provided for preventing the overflow of the electrolytes inside the integrated complex electrode cell, and a redox flow cell comprising an integrated complex electrode cell having the inner seal structure.

### BACKGROUND ART

Recently many researches on the redox flow battery (RFB) are in progress for a large capacity secondary battery since the redox flow battery has features that the maintenance cost is low while it is operable at room temperature, furthermore, the capacity and the output can be designed independently.

A redox flow battery of the prior art, as shown in FIG. 1a, which is an outline drawing, and FIG. 1b, which is a cross-sectional view, is comprised of a unit cell which includes: a pair of end plates 1 being formed at the far ends and including an electrolyte inlet and an electrolyte outlet; a pair of current collectors 2 formed inside of the end plates respectively; a pair of frames 11; a pair of bipolar plates 10 which are fixed to the frames 11 respectively; a pair of felt electrodes 25; a pair of manifolds 21, 22 which include the felt electrodes respectively; and a separating membrane 30, and the unit cell can be repeatedly stacked in series.

Specifically, as shown in FIG. 1b, a first manifold 21 and a second manifold 22, each having a felt electrodes 25 of different polarity, are formed at each side of a separating membrane 30. The bipolar plates 10, which are fixed to the frames 11, are formed at the outer sides of the first manifold 21 and the second manifold 22.

When stacking such redox flow batteries of the prior art, a first manifold 21, the frame 11 comprising a bipolar plate, and the second manifold 22 are repeatedly stacked with respect to the separating membrane 30, thus not only the volume of the stacked body (i.e. a stack) is increased but also the amount of the material to be used is increased, thereby causing the problems of increase in the cost and the stacking time.

Furthermore, the positive electrolyte and the negative electrolyte which are to be in contact with the first electrode of the first manifold (hereinafter referred to as ‘positive electrode’) and the negative electrode of the second manifold (hereinafter referred to as ‘negative electrode’) must be insulated by the bipolar plate, however, bending may occur during stacking since a graphite plate or a carbon plate having excellent conductivity is used as a bipolar plate. Therefore, there is a problem of electrolyte crossing along the surface of the bipolar plate between the felt electrodes having different polarities. Due to the longer charging time or the shorter discharging time caused by such electrolyte crossing phenomenon, the charging and discharging efficiencies and the energy efficiency will be degraded.

### SUMMARY OF INVENTION

### Technical Problem

An objective of the present invention for solving the above described problems of the prior art is to provide an integrated complex electrode cell and a redox flow cell comprising same not only for enhancing the stacking efficiency by significantly reducing the volume of the stacked body of the redox flow cell but also significantly reducing the stacking time and the cost.

Another objective of the present invention is to provide an integrated complex electrode cell and a redox flow cell comprising same capable of preventing the decrease in the charging and discharging efficiencies and the energy efficiency due to the increased charging time or the decreased discharging time by preventing the electrolyte, which is in contact with one side of the manifold, from crossing over along the surface of the bipolar plate towards the other side of the manifold when integrating by inserting the bipolar plates into the two manifolds having different polarities in order to increase the stacking efficiency by significantly reducing the volume of the stacked body of the redox flow battery.

### Solution to Problem

An integrated complex electrode cell according to the present invention for achieving the above described objectives includes: a first manifold into which a first electrode is inserted from outside; a second manifold into which a second electrode is inserted from outside; and a bipolar plate interposed between the first manifold and the second manifold.

The horizontal length and a vertical length of each of the first electrode and the second electrode may be shorter than a horizontal length and a vertical length of the bipolar plate, respectively.

Each of the first electrode and the second electrode may be a positive electrode or a negative electrode having a different polarity from each other.

The bipolar plate may be disposed on a resting seat provided inside of the first manifold and the second manifold.

The bipolar plate may be disposed on a resting seat by using an adhesive or through a thermosetting process.

In addition, a leak barrier may be formed on a contact surface of the resting seat of the bipolar plate for preventing a leakage of electrolyte.

A leak barrier material made of any material selected from the group including EPDM, Viton, rubber, soft PVC and hard PVC may be inserted in the leak barrier.

The leak barrier may have a shape of polygon or circle.

A redox flow battery according to the present invention for achieving foresaid objectives includes one of the above-mentioned integrated complex electrode cell.

The integrated complex electrode cell may be stacked with reference to a separating membrane repeatedly.

Further, a redox flow battery according to the present invention includes: a pair of end plates each having an inlet and an outlet for electrolyte; current collectors respectively located inside of the end plates; end manifolds respectively located inside of the current collectors, wherein a bipolar plate is disposed on one surface of each end manifold facing each current collector and an electrode is inserted in an opposite surface to said one surface; at least two separating membranes located between the end manifolds; and an integrated complex electrode cell formed between the two separating membranes according to the above.

### Advantageous Effects of Invention

The above described integrated complex electrode cell according to the present invention is advantageous in that the stacking efficiency is increased and the stacking process is simplified as well since the volume of the stacked body of the redox flow battery is significantly reduced by eliminating the bipolar plate frames being used in the prior art. This can be achieved by integrating the bipolar plate between the two manifolds using the resting seats formed therein.

Thus, a redox flow battery according to the present invention is advantageous in that a redox flow battery of an increased capacity compared with a redox flow battery of the prior art can be provided considering the capacity per unit volume.

Further, a redox flow battery according to the present invention is advantageous in that the manufacturing cost can be reduced by eliminating ancillary component (bipolar plate frame), and the working hours can be reduced due to the simplicity of the stacking process.

In addition, the above described integrated complex electrode cell having inner seal structure according to the present invention may effectively prevent degradation of the charging and discharging efficiencies and the energy efficiency due to a longer charging time or a shorter discharging time caused by the electrolyte crossing phenomenon. This can be achieved by preventing the electrolyte, which is in contact with one side of the manifold, from crossing over along the surface of the bipolar plates when inserting the bipolar plate between (inside) the two manifolds of different polarities for integration thereof.

### BRIEF DESCRIPTION OF DRAWINGS

FIG. 1a is a drawing illustrating the stacking structure of a redox flow battery of the prior art;

FIG. 1b is a cross-sectional view of a redox flow battery of the prior art;

FIG. 2 is an outline drawing of a stacking structure of a redox flow battery according to an exemplary embodiment of the present invention;

FIG. 3 is an exploded perspective view of an integrated complex electrode cell according to an exemplary embodiment of the present invention;

FIG. 4 is a cross-sectional view of an assembled integrated complex electrode cell illustrated in FIG. 3; and

FIG. 5 is an exploded cross-sectional view of an integrated complex electrode cell illustrated in FIG. 3.

FIGS. 6a, 6b and 6c illustrate an integrated complex electrode cell having inner seal structure according to an exemplary embodiment of the present invention FIG. 6a is an exploded perspective view; FIG. 6b is an exploded cross-sectional view; and FIG. 6c is a cross-sectional view of an assembled integrated complex electrode cell.

FIG. 7 is an exploded cross-sectional view of an integrated complex electrode cell having inner seal structure according to another exemplary embodiment of the present invention.

FIG. 8 is an exploded cross-sectional view of an integrated complex electrode cell having inner seal structure according to yet another exemplary embodiment of the present invention.

FIG. 9 is an exploded cross-sectional view of an integrated complex electrode cell having inner seal structure according to still yet another exemplary embodiment of the present invention.

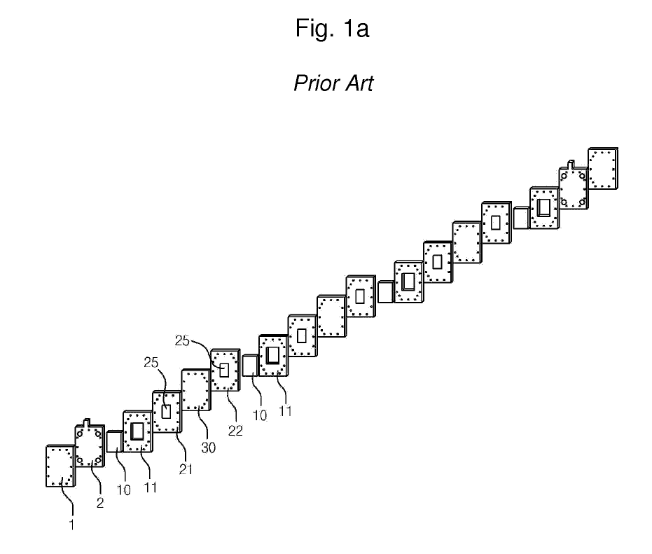

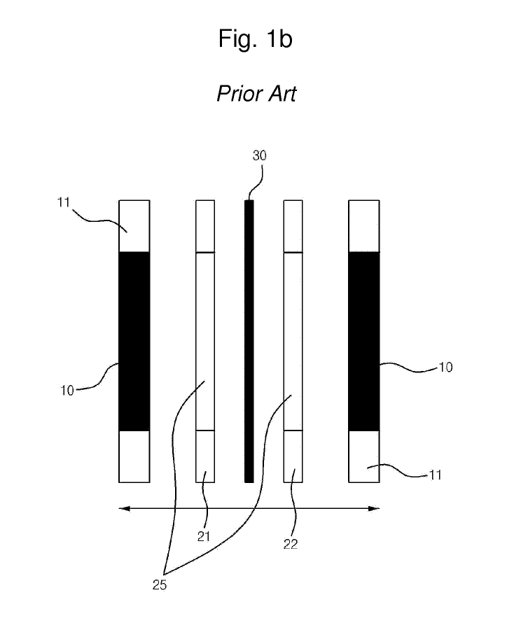

### DETAILED DESCRIPTION OF EMBODIMENT

Hereinafter, exemplary embodiments of the present invention will be described more in detail with reference to the drawings.

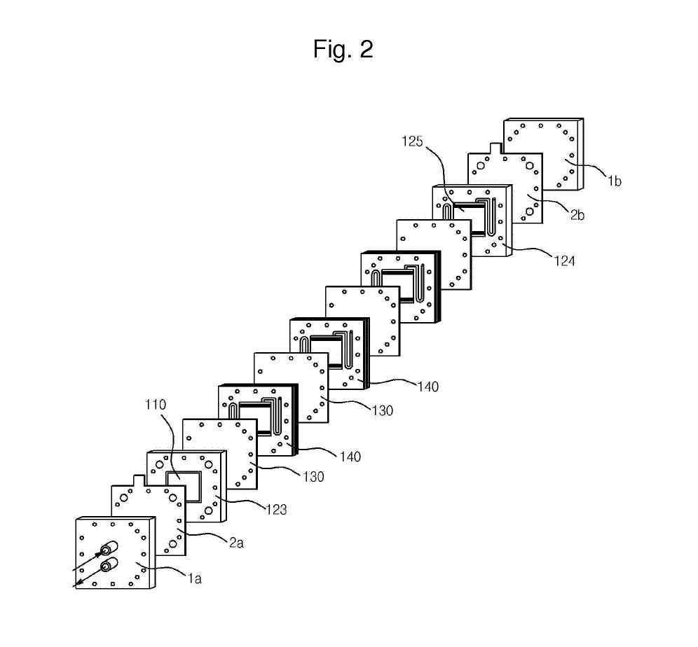

FIG. 2 is an outline drawing of a stacking structure of a redox flow battery according to an exemplary embodiment of the present invention.

As illustrated in FIG. 2, a redox flow battery according to the present invention includes: a pair of end plates 1a, 1b each having an inlet and an outlet for the electrolytes; a pair of current collectors 2a, 2b located inside of the corresponding the end plates 1a, 1b; a pair of end manifolds 123, 124 located inside of the corresponding the current collectors 2a, 2b, wherein a bipolar plate 110 is rested on the surface facing corresponding the current collector 2a, 2b and an electrode is inserted into the opposite surface; at least two separating membranes 130 located between the end manifolds 123, 124; and at least one integrated complex electrode cell 140 located between the two separating membranes 130.

The end plates 1a, 1b are being disposed at the far ends and define the outline of the overall redox flow battery, and each of them has an electrolyte inlet and an electrolyte outlet formed therein; this can be easily accomplished by forming paths for injecting or exhausting the electrolytes in a typical plate generally used in the art. Although it is not shown here, the electrolyte inlet and the electrolyte outlet are connected to the positive electrolyte tank and the negative electrolyte tank, and the positive electrolyte and the negative electrolyte are being circulated by driving the pump which is separately provided.

The end plates 1a, 1b can be formed by using insulation materials. For example, the end plates 1a, 1b can be formed by using polymers such as polyethylene (PE), polypropylene (PP), polystyrene (PS), polyvinyl chloride (PVC), and the like. Considering the price and availability, polyvinyl chloride (PVC) is preferred for forming the end plates.

Inside of the end plates 1a, 1b disposed at the far ends, the current collectors 2a, 2b are formed. The current collectors 2a, 2b are the paths for moving the electrons, and receive electrons from outside when charging, or release electrons to the outside when discharging. The two current collectors 2a, 2b located at the far ends have electrodes separated from each other.

Such current collectors 2a, 2b are commonly used in the art and not limited to a specific type, for example, copper or brass may be used.

The end manifolds 123, 124 are located inside of the corresponding the current collectors 2a, 2b, wherein a bipolar plate 110 is rested on the surface facing corresponding the current collector 2a, 2b and an electrode is inserted into the opposite surface.

For the bipolar plate 110, a conductive plate which is commonly used in the art may be used. Preferably, a conductive graphite plate may be used for the bipolar plate 110. Preferably, a graphite plate impregnated in phenol resin may be used for the bipolar plate 110. When using only graphite plate, since the strong acid which is used in the electrolyte may penetrate graphite, it is preferred to use a graphite plate impregnated in phenol resin in order to prevent the penetration of the strong acid.

The electrode provides an active site for oxidation and reduction of the electrolytes, any electrode which is commonly used in the art can be used without limitation. Preferably a felt electrode can be used.

For example, non-woven fabrics, carbon fiber, carbon paper, and the like may be used for the felt electrode. Preferably, the felt electrode may be a carbon fiber felt electrode formed by a polyacrylonitrile (PAN) based or a rayon based material.

The end manifolds 123, 124 may be used as an anode or a cathode according to the location thereof, and a flow path is formed on the surface wherein the electrode is inserted for the movement of a positive electrolyte or a negative electrolyte according to the usage.

According to the present invention, it is comprised of at least two separating membranes 130 located between the end manifolds 123, 124, and at least one integrated complex electrode cell 140 located between the two separating membranes 130.

The separating membranes 130 separate positive electrolyte and negative electrolyte, and selectively allow flowing of ions when charging or discharging. Such separating membranes 130 are commonly used in the art, and not limited to any specific type.

An integrated complex electrode cell 140 according to the present invention is provided between the two separating membranes 130. Although a positive manifold, a bipolar plate 110, and a negative electrode are separately formed in a redox flow battery of the prior art, instead, an integrated complex electrode cell 140 is provided wherein all those components are integrated. Hereinafter, the structure and the like of the integrated complex electrode cell 140 will be described in detail.

The integrated complex electrode cell 140 can be repeatedly stacked with respect to the separating membranes 130 to meet the capacity of the redox flow battery. That is, the integrated complex electrode cell 140 and the separating membrane 130 can be repeatedly stacked, and the number of stacks is not limited, and can be properly modified to meet the designed capacity of the battery.

Although it is not shown here, a redox flow battery according to the present invention further includes: a positive electrolyte tank for storing positive electrolyte, a negative electrolyte tank for storing negative electrolyte, and a pump for circulating the positive electrolyte and negative electrolyte. Since this can be easily implemented by a person of skill in the art, the detailed description on this issue will be omitted.

Furthermore, a commonly used electrolyte can be used without limitation for the positive electrolyte and negative electrolyte. Since this also can be easily implemented by a person of skill in the art, the detailed description on this issue will be omitted.

Hereinafter, the integrated complex electrode cell 140 will be described in detail.

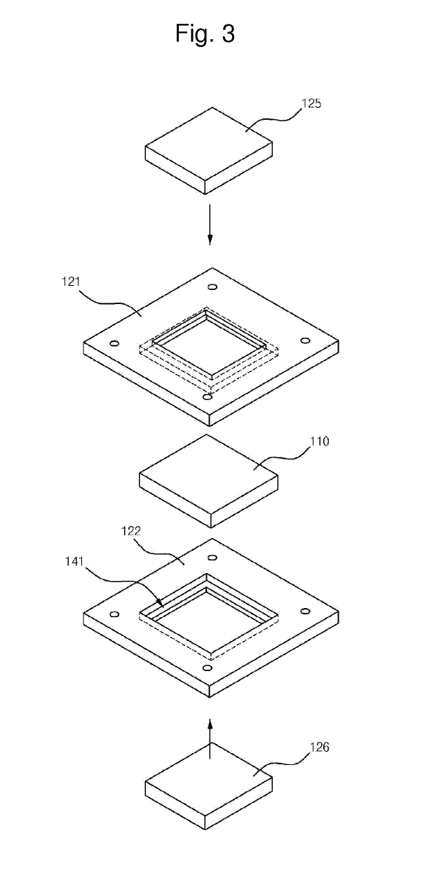

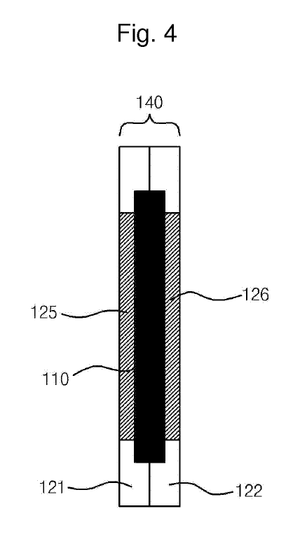

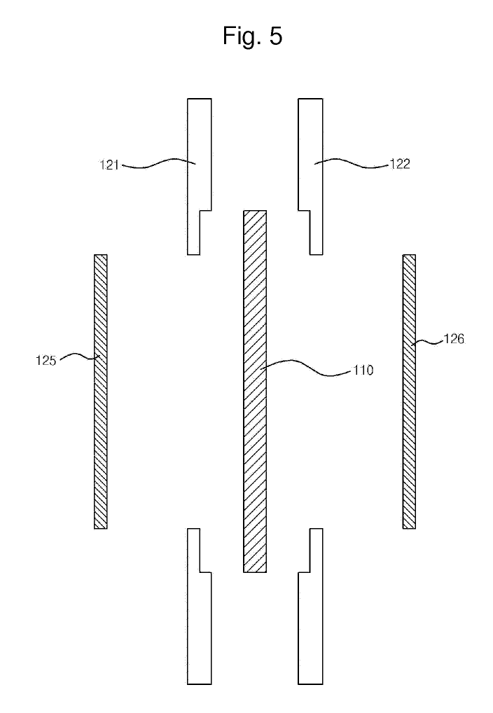

FIG. 3 is an exploded perspective view of an integrated complex electrode cell according to an exemplary embodiment of the present invention; FIG. 4 is a cross-sectional view of an assembled integrated complex electrode cell illustrated in FIG. 3; and FIG. 5 is an exploded cross-sectional view of an integrated complex electrode cell illustrated in FIG. 3. As shown in FIGS. 3 to 5, an integrated complex electrode cell according to the present invention includes: a first manifold 121 wherein a first electrode 125 is inserted into the outside thereof; a second manifold 122 wherein a first electrode 126 is inserted into the outside thereof; and a bipolar plate 110 which is being seated between the first manifold 121 and the second manifold 122.

Since the same plate that has been described previously can be applied to foresaid bipolar plate 110, the detailed description on this issue will be omitted.

The bipolar plate 110 is rested on the resting seats 141 formed in the first manifold 121 and the second manifold 122. By fixing the bipolar plate 110 in the resting seats 141 inside of the first manifold 121 and the second manifold 122, the frame of the bipolar plate 110 may possibly be removed.

The bipolar plate 110 can be rested on the resting seats 141 by using an adhesive or through a thermosetting process. Since the bipolar plate 110 is rested on the resting seats 141 inside of the first manifold 121 and the second manifold 122, it can possibly be fixed without a frame for the bipolar plate 110.

Thus the manufacturing cost can be reduced by eliminating a frame for the bipolar plate 110 which is required in the prior art, and the leak caused by the difference in the flatness and the mismatching phenomenon can be prevented. Above all, a structure for a redox flow battery, wherein the capacity per volume of the redox flow battery is increased owing to the decrease in the volume of the stack, can be provided. In addition, the man hours can be reduced due to the simplicity of the stacking process.

A first electrode 125 or a second electrode 126 is inserted outside of the first manifold 121 and the second manifold 122. A foresaid felt electrode may be used for the first electrode 125 and the second electrode 126. However, the first electrode 125 and the second electrode 126 may be distinguished as a positive electrode or a negative electrode having a different polarity depending on the polarity of the electrolyte which is in contact with the corresponding electrode.

At this time, the horizontal and the vertical lengths of the first electrode 125 and the second electrode 126 are formed to be smaller than that of the bipolar plate 110. In other words, the size of the first electrode 125 and the second electrode 126 needs to be smaller than the bipolar plate 110.

A flow path is provided on the surface of the first manifold 121 and the second manifold 122 where the first electrode 125 or the second electrode 126 is being inserted therein. A positive or a negative electrolyte is being flowed through the flow path, which is a path for the movement of the electrolyte, and the shape of the flow path may be modified in various ways. In addition, an inlet or an outlet may be provided in the first manifold 121 and the second manifold 122 for supplying or exhausting a positive or a negative electrolyte to and from the flow path, which can be easily formed by a person of ordinary skill in the art.

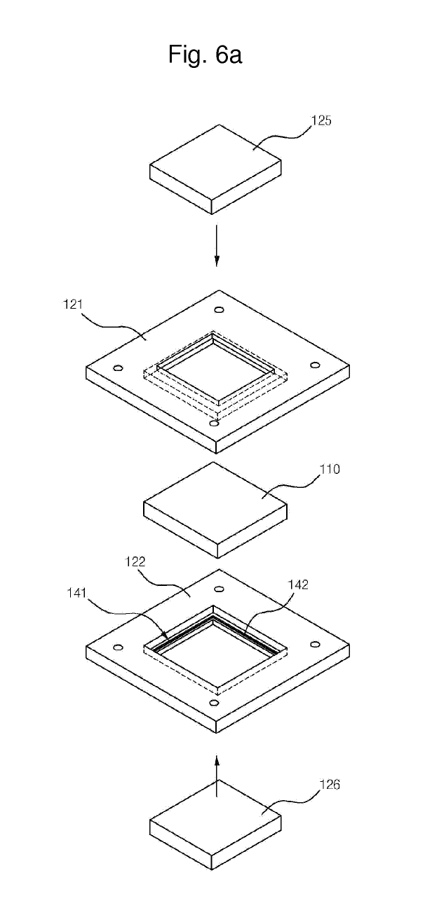

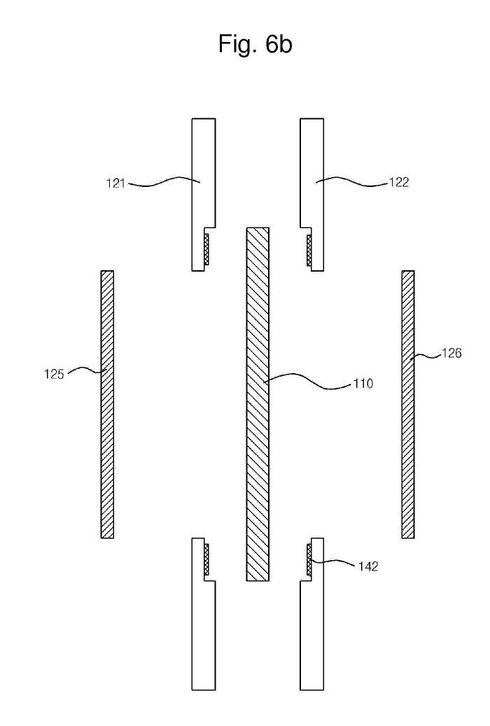

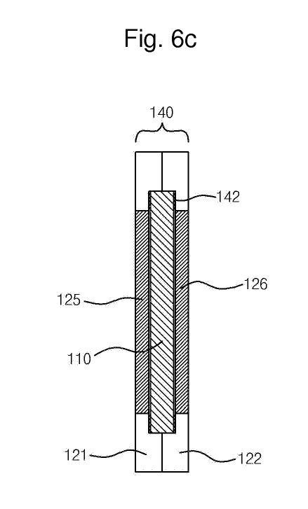

FIG. 6 illustrates an integrated complex electrode cell having inner seal structure according to an exemplary embodiment of the present invention: FIG. 6a is an exploded perspective view; FIG. 6b is an exploded cross-sectional view; and FIG. 6c is a cross-sectional view of an assembled integrated complex electrode cell.

As illustrated in FIG. 6, an integrated complex electrode cell 140 includes: a first manifold 121 wherein a first electrode 125 is inserted into the outside thereof; a second manifold 122 wherein a first electrode 126 is inserted into the outside thereof; and a bipolar plate 110 which is being seated between the first manifold 121 and the second manifold 122, wherein

A leak barrier 142 for preventing the leakage of the electrolytes is formed in at least one of the resting seats 141 provided in the first manifold 121 and the second manifold 122.

The leak barrier 142 is provided for preventing the positive and the negative electrolytes in contact with the first manifold 121 and the second manifold 122, from crossing over along the surface of the bipolar plate 110 towards the opposite direction.

In order to prevent the leakage of the electrolytes effectively, the leak barrier 142 may be formed separately on the resting seats 141 of the first manifold 121 and the second manifold 122.

The leak barrier 142 may be formed on the bipolar plate 110 in contact with the resting seats 141 of the first manifold 121 and the second manifold 122.

A leak barrier material to be applied to the leak barrier 142 may be made of a material selected from the material group including EPDM, Viton, rubber, soft PVC, and hard PVC.

As described above, when a leak barrier 142 is applied to an integrated complex electrode cell 140, the leak barrier 142 prevents the electrolyte, which is in contact with one side of the manifold, from crossing over along the surface of the bipolar plate 110 when inserting the bipolar plate 110 between (inside) the two manifolds 121, 122 for integration thereof, thus the degradation of the charging and discharging efficiencies and the energy efficiency due to a longer charging time or a shorter discharging time caused by the electrolyte crossing-over phenomenon can be effectively prevented.

The leak barrier 142 can be modified in various ways.

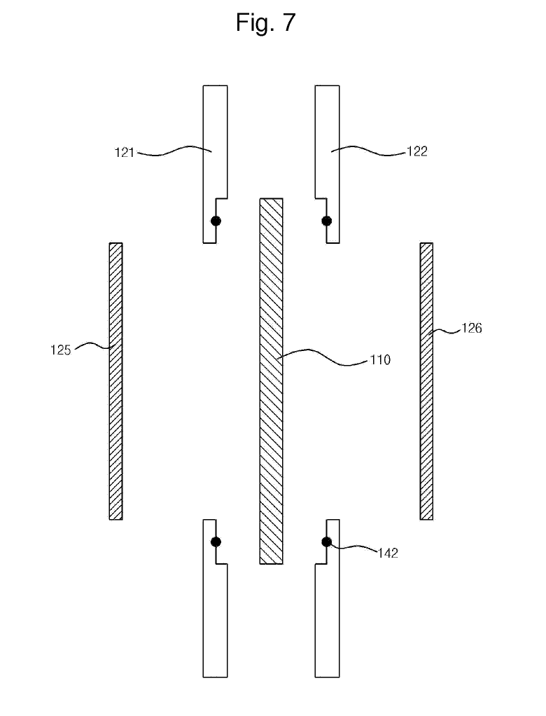

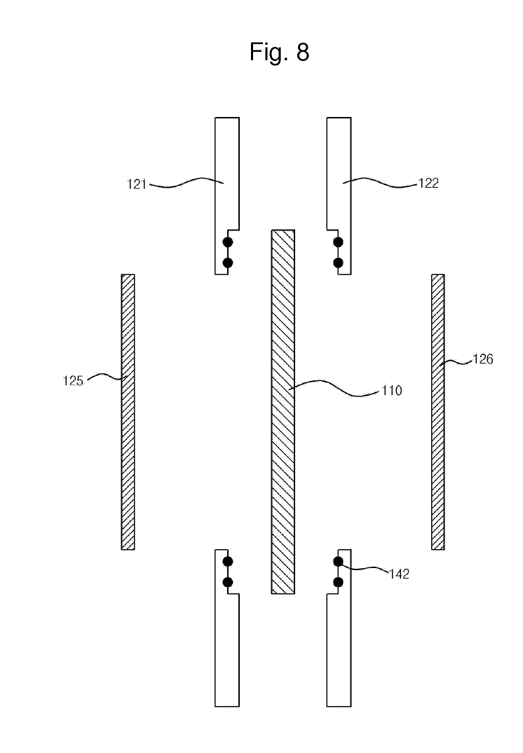

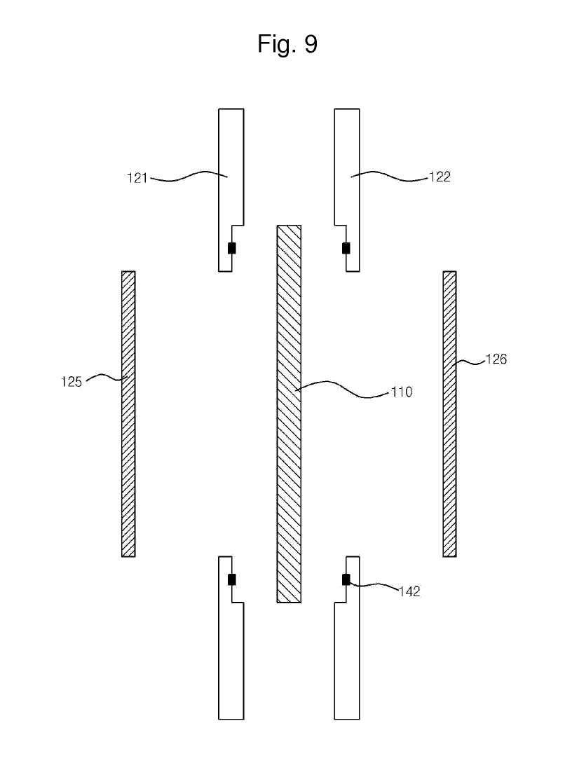

FIGS. 7 to 9 are the exploded cross-sectional views of an integrated complex electrode cell having inner seal structure according to the exemplary embodiments of the present invention. As shown in FIGS. 7 to 9, a leak barrier 142 applied to an integrated complex electrode cell 140 according to another exemplary embodiment of the present invention may be the one obtained by forming concave grooves in the resting seats 141 of the first manifold 121 and the second manifold 122 respectively, and inserting the leak barrier materials into the concave grooves.

At this time, the leak barrier 142 may be formed by inserting a leak barrier material comprising one O-ring, or more than two O-rings into the concave grooves of the resting seats 141. Furthermore, various shapes having cross-sections such as a circular shape, a rectangular shape, and the like may be applied to the leak barrier material of the leak barrier 142.

According to the present invention, although the details are not shown in the drawings, the leak barrier 142 may be formed in at least one of the surfaces of the bipolar plate 110 in contact with the resting seats 141 of the first manifold 121 and the second manifold 122. That is, unlike the case wherein the foresaid leak barrier 142 is formed in the resting seats 141 of the first manifold 121 and the second manifold 122, the leak barrier 142 is formed on the contact surfaces of the bipolar plate 110. Since both have an identical structure except the foresaid differences, the detailed description on this matter will be omitted.

### Experimental Example

A redox flow battery having a structure, as illustrated in FIG. 2, has been constructed in order to verify the crossing-over phenomenon of the positive and the negative electrolytes through the bipolar plate (graphite conductive plate, GCP). However, non-porous hard PVC is used instead of the separating membrane in order to exclude the crossing-over phenomenon of the electrolyte through the separating membrane. A 5 mm thick graphite fiber sheet is used as an electrode, and cells are constructed by cutting the graphite fiber sheet to have an area of 30 cm². At this time, as illustrated in FIG. 7, the integrated complex electrode cell is constructed to have a structure wherein the O-rings are separately formed in the first manifold and the second manifold respectively.

In addition, a positive electrolyte tank, a negative electrolyte tank, and a pump are provided for enabling the flow of the electrolyte of a redox flow battery. In the positive electrolyte tank, 2 moles of vanadium was dissolved into 2 moles of sulfuric acid solution and blue vanadium (IV) electrolyte was injected therein, while 2 moles of sulfuric acid aqueous solution was injected into the negative electrolyte tank. Each of two 80 ml electrolytes was injected into the corresponding tank, and the electrolytes were being flowed through the stacked body using the pump at a speed of 80 ml per minute.

At this time, the temporal change in the level of electrolyte was observed, and the absorbance was verified using the Perkin Elmer's UV/Vis spectrometer Lambda2. In order to verify the absorbance, a 2 ml negative electrolyte was collected, and thereafter the absorbance value change was measured. After the measurement, the collected electrolyte was again injected into the negative electrolyte tank so that the experiment could proceed with the same electrolyte level.

The produced vanadium (VI) sulfuric acid aqueous solution showed a maximum absorption wavelength at 760 nm, and a vanadium (VI)-free negative electrolyte was collected for observing the absorbance value change occurring as the electrolyte was crossing over.

The results showed no change in the negative electrolyte level and the absorbance value during the 200 hour experiment process as shown in Table 1 below. This means that the internal sealing of the electrode was well done since there was no electrolyte leaking phenomenon via the electrode.

TABLE 1

| Elapsed Time | Level of Negative | Absorbance Value Change in |
|---|---|---|
| [hr] | Electrolyte [ml] | Negative Electrolyte |
| 0 | 80 | none |
| 1 | 80 | none |
| 5 | 80 | none |
| 10 | 80 | none |
| 20 | 80 | none |
| 40 | 80 | none |
| 60 | 80 | none |
| 80 | 80 | none |
| 100 | 80 | none |
| 120 | 80 | none |
| 140 | 80 | none |
| 160 | 80 | none |
| 180 | 80 | none |
| 200 | 80 | none |

As described above, a redox flow battery according to the present invention is advantageous in that the stacking efficiency is increased and the stacking process is simplified as well since the volume of the stacked body of the redox flow battery is significantly reduced compared with the redox flow battery of the prior art by including an integrated complex electrode cell 140 wherein the bipolar plate 110 is rested between the two manifolds forming an integrated structure. Thus, a redox flow battery according to the present invention is advantageous in that a redox flow battery of an increased capacity compared with a redox flow battery of the prior art can be provided considering the capacity per unit volume.

In addition, an integrated complex electrode cell having a leak barrier according to the present invention can prevent degradation of the charging and discharging efficiencies and the energy efficiency by preventing the electrolyte crossing phenomenon caused by the bipolar plated rested between the first manifold and the second manifold.

In the foregoing description, although the present invention is described with reference to the accompanying drawings as an example, this is provided to assist understanding of the present invention. The present invention is not limited to this, and any person of ordinary skill in the art shall understand that various changes and modification are possible from this example. Thus the present invention comprehensively includes all such alternatives, amendments, modifications, and changes which belong to the spirit and the scope of the appended claims.

<Explanations of Reference Characters>

| | |
|---|---|
| 1a, 1b: end plate | 2a, 2b: current collector |
| 10, 110: bipolar plate | 11: bipolar plate frame |
| 21, 121: first manifold | 22, 122: second manifold |
| 123, 124: end manifold | 25: electrode |
| 125: first electrode | 126: second electrode |
| 30, 130: separating membrane | 140: integrated complex |

electrode cell

| | |
|---|---|
| 141: resting seat | 142: leak barrier |

1. An integrated complex electrode cell comprising:
a first manifold into which a first electrode is inserted from outside;
a second manifold into which a second electrode is inserted from outside; and
a bipolar plate interposed between the first manifold and the second manifold.

2. The integrated complex electrode cell according to claim 1, wherein a horizontal length and a vertical length of each of the first electrode and the second electrode are shorter than a horizontal length and a vertical length of the bipolar plate, respectively.

3. The integrated complex electrode cell according to claim 1, wherein each of the first electrode and the second electrode is a positive electrode or a negative electrode having a different polarity from each other.

4. The integrated complex electrode cell according to claim 1, wherein the bipolar plate is disposed on a resting seat provided inside of the first manifold and the second manifold.

5. The integrated complex electrode cell according to claim 1, wherein the bipolar plate is disposed on a resting seat by using an adhesive or through a thermosetting process.

6. The integrated complex electrode cell according to claim 1, wherein a resting seat is formed inside of the first manifold and the second manifold, and a flow path is formed outer sides thereof.

7. The integrated complex electrode cell according to claim 4, wherein a leak barrier for preventing the leakage of the electrolytes is formed in at least one of the resting seats provided in the first manifold and the second manifold.

8. The integrated complex electrode cell according to claim 4, wherein a leak barrier is formed on a contact surface of the resting seat of the bipolar plate for preventing a leakage of electrolyte.

9. The integrated complex electrode cell according to claim 7, wherein a leak barrier material made of any material selected from the group including EPDM, Viton, rubber, soft PVC and hard PVC is inserted in the leak barrier.

10. The integrated complex electrode cell according to claim 9, wherein the leak barrier has a shape of polygon or circle.

11. A redox flow battery comprising at least one integrated complex electrode cell according to claim 1.

12. A redox flow battery wherein the redox flow battery includes an integrated complex electrode cell according to claim 9.

13. A redox flow battery wherein the redox flow battery includes an integrated complex electrode cell according to claim 10.

14. The redox flow battery according to claim 11, wherein the integrated complex electrode cell is stacked with reference to a separating membrane.

15. A redox flow battery comprising:
a pair of end plates each having an inlet and an outlet for electrolyte;
current collectors respectively located inside of the end plates;
end manifolds respectively located inside of the current collectors, wherein a bipolar plate is disposed on one surface of each end manifold facing each current collector and an electrode is inserted in an opposite surface to said one surface;
at least two separating membranes located between the end manifolds; and
an integrated complex electrode cell formed between the two separating membranes according to claim 1.

16. The integrated complex electrode cell according to claim 8, wherein a leak barrier material made of any material selected from the group including EPDM, Viton, rubber, soft PVC and hard PVC is inserted in the leak barrier.

17. The integrated complex electrode cell according to claim 16, wherein the leak barrier has a shape of polygon or circle.

18. A redox flow battery comprising at least one integrated complex electrode cell according to claim 16.

19. A redox flow battery wherein the redox flow battery includes an integrated complex electrode cell according to claim 17.
